(19) United States
(12) Patent Application Publication
(10) Pub. No.: US 2005/0131789 A1
(43) Pub. Date: Jun. 16, 2005

(54) Method and system for offering short term derivative instruments

(76) Inventor: Eliezer Mintz, East Brunswick, NJ (US)

Correspondence Address: BROWN, RAYSMAN, MILLSTEIN, FELDER & STEINER LLP, 900 THIRD AVENUE, NEW YORK, NY, 10022, US

(21) Appl. No.: 10/859,026

(22) Filed: Jun. 1, 2004

Related U.S. Application Data
(63) Continuation of application No. 10/230,977, filed on Aug. 29, 2002, now abandoned.

(51) Int. Cl. G06F 17/60

(52) U.S. Cl. 705/35

(57) ABSTRACT

Described herein are methods and systems for providing a new type of financial instrument which offers a well-defined return after a set, very short time period. The instrument is in the form of a derivative or option and its return is based on the change in value of one or more investment vehicles such as a stock or bond index. In particular, an embodiment of the derivative instrument is one which returns either nothing or an amount determined by sums invested in the derivative instrument and one or more complementary derivative instruments, the complementary derivative instrument(s) being based on differing outcomes in value changes than the derivative instrument.

### BACKGROUND OF THE INVENTION

Investors trade in various financial instruments with a variety of goals. Some investors put their money into blue chip stocks, bonds, or market indexes with the goal of long term or relatively secure growth of the money for use in retirement or the like. Some investors, including less risk-averse individuals and institutional investors, are more active participants in the market and are concerned with shorter term growth, on the order of several months or a year. Still others are more concerned with much shorter term profits, and actively speculate on changes in the value of a stock or other instrument within the course of a single trading session. The proliferation of on-line and Internet-based trading systems provides opportunities for faster access to data and for quicker trading.

To accommodate the increasingly wide variety of investor personalities and goals, several companies have begun offering new types of investment-related financial activities. For example, VSMarket.com offers a financial entertainment product which allows users to bet on which predetermined stocks will increase the most or decrease the least during the course of a trading day. As another example, Blue Square is an online interactive betting service which allows users to place bets on the numerical value of various individual financial indexes at different periods of time. For example, users may bet on the daily, monthly, or annual close values of the Dow Jones Industrial Average, the NASDAQ Composite Index, the Nikkei 225 Index, and other well-known financial indices. Cantor Index Ltd. offers users the option to place financial spread bets on the value of a variety of individual financial items including indices, individual stocks, commodities, currencies, bond rates, and options.

As another example, Longitude, Inc. provides a Parimutuel Digital Call Auction™ (“PDCA”) further discussed in U.S. Pat. No. 6,321,212, which is hereby incorporated herein by reference. Users purchase PDCA options as a hedge against a variety of possible financial outcomes such as unexpected changes in key interest rates, corporate earnings, weather patterns, and other similar events which might significantly affect financial returns of their other investments.

One common factor associated with all of these existing investments as well as existing trading systems and instruments is the need for the investor to wait an open-ended or long amount of time before seeing any return. Even a day trader who buys stocks in the hopes of selling them very soon thereafter has little guarantee of seeing a well-defined return within a limited and well-defined amount of time. Rather, any possibility of return depends largely on the vagaries of the market and numerous other factors. In addition, the trader must diligently watch the security being traded to determine whether and when to trade and realize a return.

Therefore, there continues to be interest in a type of financial instrument that provides a definable return in a well-defined, limited, short period of time.

### BRIEF SUMMARY OF THE INVENTION

Described herein are methods and systems for providing a new type of financial instrument which offers a well-defined return after a set, very short time period. The instrument is in the form of a derivative or option and its return is based on the change in value of one or more investment vehicles such as a stock or bond index. In particular, an embodiment of the derivative instrument is one which returns either nothing or an amount determined by sums invested in the derivative instrument and one or more complementary derivative instruments, the complementary derivative instrument(s) being based on differing outcomes in value changes than the derivative instrument.

For example, a derivative may be based on the change in value of a Dow Jones index as compared to a second index such as a NASDAQ index over a one or two minute period at set start and end times, while its complement derivative may be based on the change in value of the NASDAQ index as compared to the Dow Jones index. The return on the Dow Jones index derivative instrument is a function of the amounts invested by all investors in that instrument as a ratio to the amounts invested by all in the complement derivative. As another example, a derivative may be based on an increase in value of an index over a one or two minute time period at set start and end times, while its complement derivative may be based on a decrease in the index's value during that time.

Thus, in accordance with one aspect of the invention, a method is provided for offering short term investments, the method involving storing data representing a set of two or more investment vehicles having values that change over time, and accepting investments in a plurality of derivative instruments from investors, the derivative instruments each representing relative value change of one of the investment vehicles as compared to the one or more other investment vehicles in the set over a defined, near real-time period. The time period has a duration long enough to allow for a high probability of value change in the investment vehicles in the set. The investment vehicles may be stock or bond indexes, mutual funds, or individual stocks, bonds, options or derivatives which are regularly and very frequently traded. The method further involves providing a return on the derivative instruments following the defined time period based upon the relative value change of the investment vehicles.

In accordance with the invention, the near real-time time period is very short as compared to longer investment periods such as full trading sessions, days, months, etc. In one embodiment, the time period is defined to have a duration to allow for only a few value changes in the investment vehicles during the time period. Historical data showing rates of value change of the investment vehicles may be used to determine just how long the time period should be to allow for a high probability of a few value changes. In other embodiments, the time period is defined to have a duration short enough to retain nearly continuous interest of the investors in value changes of the investment vehicles during the time period. In this regard, the method may further include tracking the values of the investment vehicles during the defined time period and displaying to the investors the tracked value changes of the investment vehicles during the defined time period.

When the investment vehicles upon which the derivative instruments are derived include indexes, such as a Dow Jones index, a NASDAQ index, a Standard & Poor's 500 index, or a Russell index, the duration of the defined time period may be five minutes or less. In many cases, the duration of the defined time period may be as little as one minute. Based on historical or empirical results, even a one minute period is long enough to allow for several value changes in these indexes.

The return on the derivative instrument may be provided only to one or more investors in the derivative instrument whose associated investment vehicle's relative value change as compared to the other one or more investment vehicles in the set is favorable according to a predetermined criteria. In one embodiment, the return is provided to the investors in the derivative instrument whose associated investment vehicle's percentage value change as compared to percentage value changes of the other one or more investment vehicles in the set is favorable according to the predetermined criteria. For example, the return may be provided if the percentage value change of the investment vehicle increases more than or decreases less than the percentage value changes of the other one or more investment vehicles. The investment vehicle may be said to have thus performed better than the other investment vehicles.

The return may be computed for each investor as a function of an amount invested by the investor in the investor's derivative instrument and amounts invested in each of the derivative instruments. For example, the return may be computed according to a pari-mutuel return rule. In addition, investors may be informed, in advance of the defined time period, of the projected return based upon investments received to that point. Thus, the method may include, at each of a plurality of given times prior to the defined time period, computing a projected return for each derivative instrument and transmitting the projected returns to potential investors for display on display devices.

In accordance with other aspects, the invention provides a method for offering short term investments involving, for a selected investment vehicle, defining a period of time having a duration long enough to allow for a high probability of at least one value change in the investment vehicle during the time period but not more than a few value changes in the investment vehicle during the time period. Investments in a plurality of derivative instruments are accepted from investors, the derivative instruments each representing one of a plurality of possible value changes of the investment vehicle over the defined time period. A return is computed on the derivative instruments for each investor as a function of an amount invested by the investor in the investor's derivative instrument and amounts invested in each of the derivative instruments, and a return is provided on the derivative instruments following the defined time period based upon the value change of the investment vehicle. In some embodiments, the investments include two derivative instruments, a first derivative instrument representing an increase in value of the investment vehicle over the defined time period and a second derivative instrument representing a decrease in value of the investment vehicle over the defined time period.

In another aspect, the invention provides a computerized exchange to enable the purchase of short-term derivative instruments including those described above. The exchange according to this aspect enables individuals, brokers, and dealers to communicate purchase orders for the short-term derivative instruments using a simple communications protocol. For example, a user might send a message to the exchange such as “Buy X dollars of short-term derivative instrument Y.” The exchange may also provide confirmation for each trade once the trade is completed, send back the results and returns for each investment to the user when the short-term financial derivative instrument expires, and provide reporting capabilities such as daily, weekly, monthly, and yearly reports by user or short-term financial derivative instrument.

In some embodiments, the exchange nets all investments made by a specific user and debits or credits his account at a third party account with the remaining amount. The exchange may have risk management capabilities, in which the exchange maintains an “at risk” position for each user which will be limited to a specific amount.

In another aspect, the invention provides a computerized broker through which customers may purchase the short-term derivative instruments as described herein. The broker may be dedicated to only providing short-term derivative instruments. The broker may provide reports to each customer detailing their trading history, including daily and monthly trading activity, their account profile, and other relevant information.

In another aspect, the invention provides a computerized quote server to disseminate information regarding the expected or projected return for the short-term derivative instruments at a given time. In one embodiment, the quote server calculates the rate of return for short-term derivative instruments based on information regarding the amount invested in each short-term financial derivative instrument at the time. The rate of return may be computed according to a pari-mutuel return rule or formula.

### BRIEF DESCRIPTION OF THE DRAWINGS

The invention is illustrated in the figures of the accompanying drawings which are meant to be exemplary and not limiting, in which like references are intended to refer to like or corresponding parts, and in which:

FIGS. 1A-1B contain a flow chart showing a process of offering short term derivative instruments in accordance with one embodiment of the present invention;

FIG. 2 is an exemplary screen display of ongoing and final results of investment vehicles covered by two short-term financial instrument derivatives in accordance with one embodiment of the present invention;

FIG. 3 is an exemplary screen display of ongoing and final results of investment vehicles covered by five short-term financial instrument derivatives in accordance with one embodiment of the present invention; and

FIG. 4 is a block diagram depicting a high level view of the network architecture and components of a system in accordance with one embodiment of the present invention.

FIG. 5 is a block diagram depicting a view of the network architecture and components of a system in accordance with one embodiment of the invention.

### DETAILED DESCRIPTION OF THE PREFERRED EMBODIMENTS

Preferred embodiments of methods, systems, and computer programs according to the invention are described through reference to the Figures.

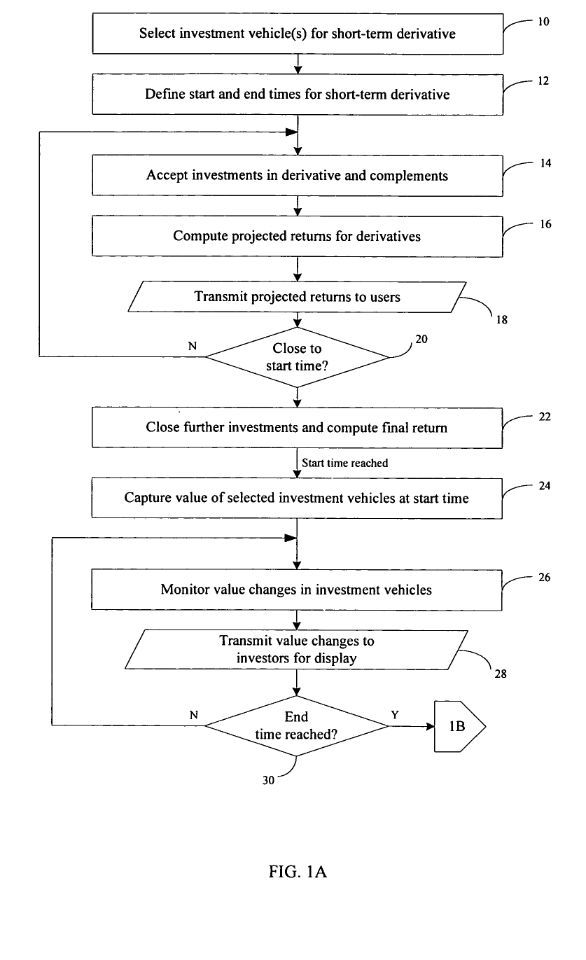

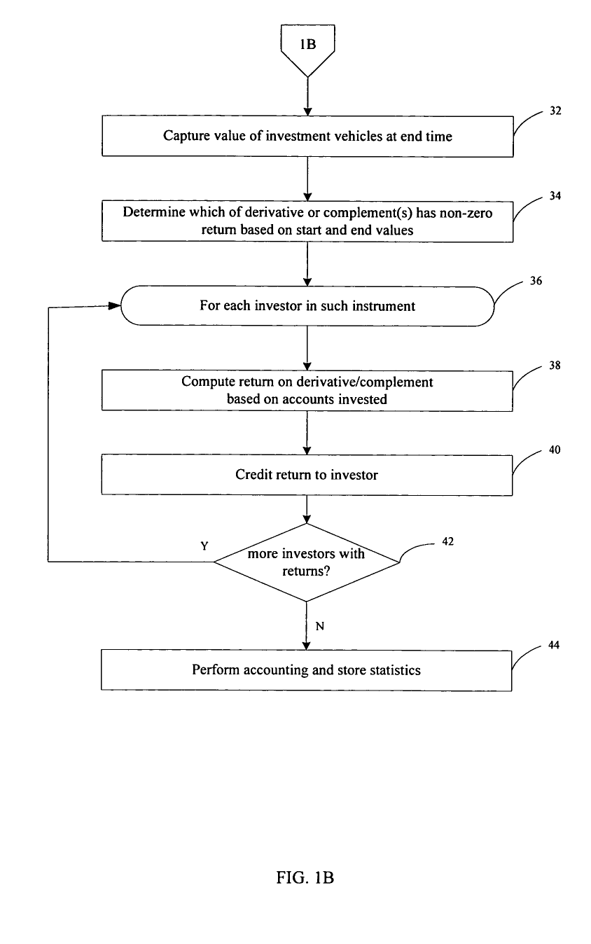

A method of offering short term derivatives in accordance with embodiments of the present invention is shown in FIGS. 1A-1B. First, the derivative instrument is defined by selecting one or more investment vehicles upon which to base the derivative, step 10, and selecting a start and end time, step 12, or a start time and duration. To have the derivative provide results in a very short period, the duration of the derivative is preferably near real-time, allowing for the return to be determined almost immediately following the start time. The selection of the investment vehicles must therefore be made such that the investment vehicle will change in value within the short time. This selection takes into account historical or empirical results of trading activity in the investment vehicle during a similar time period as the start time.

For example, it is known from prior trading activity that many stock or bond indexes change in value at least once every 10-15 seconds during a trading session. These include indexes such as various Dow Jones indexes, NASDAQ indexes, Standard & Poor's indexes, and Russell indexes, among others. These indexes include foreign indexes such as various Nikkei indexes, Hang Seng indexes, CAC indexes, FTSE indexes, DAX indexes, IPC indexes, and Shanghai Composite indexes, among others.

In some embodiments, the duration is chosen to be long enough to allow for only a few such value changes. Thus, a derivative in accordance with the invention having a return based on the change in value of one or more indexes can have a duration as short as one or two minutes. The selection of the derivative's duration may also be based on a desire to retain nearly continuous interest of the investors in the outcome. That is, a derivative having a return that will take many hours to be determined will likely not retain an investor's interest in observing the continuous change in the value of the base index or indexes. Thus, in some embodiments, it is desirable to limit the length of the duration to about five to fifteen minutes.

Once one or more investment vehicles and a start and end time is determined, the derivative is defined using rules which determine how a return is achieved. In the case of a single investment vehicle, the derivative is based on two or more possible changes in value of the underlying vehicle, such as the vehicle increasing or decreasing in value, or increasing in value by first, second, and third different amounts or percentages, and the like. In the case of two or more investment vehicles, the derivative is based on the relative movement or change in value between the two or more vehicles. For example, a derivative based on two indexes would be based on which of the two indexes performed better during the time period, meaning which increased more or, if both decreased in value, which decreased less.

In a preferred embodiment, the short-term derivative instrument returns either nothing or an amount determined by the sums invested in the short-term financial derivative instrument and its complements according to a pari-mutuel betting system. For example, a one minute DOW-NASDAQ derivative instrument would return nothing if the NASDAQ rose more or declined less percentage-wise than the DOW between a start time of 10:00 and an end time of 10:01, and a sum dependent on the amounts invested in the DOW-NASDAQ (D) short-term financial derivative instrument relative to the NASDAQ-DOW (N) short-term financial derivative instrument. The return per dollar invested R would be:
R=(1+N/D)*(1−C)
where:
N=amount invested in NASDAQ short-term financial instrument derivative;
D=Amount invested in DOW short-term financial instrument derivative; and
C=Commission amount of offerer.

For example, if equal amounts were invested (N=D) and the commission C is 10%: for every $1 invested $1.80 would be returned for a return of 80%.

In one embodiment, the return on a derivative comparing the changes in three or more investment vehicles is computed using a pari-mutuel return rule. Computations are based upon the total amount invested in all of the investment vehicles. If there are n investment vehicles, then the sum total amount invested M can be represented by the equation:

$$M = {M}_{1} + {M}_{2} + … + {M}_{n} = {\sum }_{i = 1}^{n} {M}_{i}$$

where Mᵢ=amount invested in each vehicle i, for n vehicles.

The return per dollar invested Rᵢ in a particular investment vehicle Mᵢ would be:
Rᵢ=M(1−C)/Mᵢ
where:
C=Commission amount of offerer; and the return on investment ROI per dollar would be:
   ROI=R₁−1

For example, if equal amounts totaling $100 were invested in four different investment vehicles, and the commission C is 10%: for every $1 invested $3.60 would be returned for a return on investment of 260%.

In some embodiments, a “super” derivative offers a return based upon the performance of a combination of two or more derivatives, each being a different short time period. For example, the return of a “super” derivative may be based upon the change in value of the Dow Jones index from 10:30 AM to 11:00 AM, the change in value of the Dow Jones index from 11:00 AM to 11:30 AM, and the change in value of the NASDAQ index from 11:30 AM to 12:00 PM. As another example, the return of a “super” derivative may be based upon the relative change in value of the Dow Jones index and the CAC index from 9:30 AM to 9:35 AM, the relative change in value of the NASDAQ index and the Russell index from 9:35 AM to 9:45 AM, and the relative change in value of the FTSE index and the S&P 500 index from 9:45 AM to 10:00 AM.

In one embodiment, the base of the short-term derivative instrument is designated by a four letter ticker. Following the base, a number designates the outcome invested in, followed by the date, start time, and duration of the short-term derivative instrument. For example, the a short-term derivative instrument that is based on the Dow Jones Industrial Average, the NASDAQ, and the S&P 500 index is designated DNSP. If the outcome invested in is the NASDAQ index at 10 am on Mar. 15, 2002 and the lifetime of the short-term financial derivative instrument is one minute then the designation would be:
DNSP2|03/15/2002|10:00|60

Returning to FIG. 1A, at some point prior to the start time, investments in the derivative and its one or more complements are accepted from investors, step 14. As explained further below, investments and payments are accepted electronically such as through an exchange computer. Typically, investments would begin to be accepted a short time before the start time, e.g., an hour or half hour. In this context, a complement of a derivative refers to another derivative instrument representing a different, perhaps opposite, result to the derivative. For example, the Dow/Nasdaq comparison described above would have a derivative based on the Dow and a complement based on the Nasdaq. As explained further below, investments in these instruments are accepted through brokers, such as broker computers operating through the Internet.

Once investments begin to come in, projected returns on the derivatives are computed, step 16. The projected returns are computed based on the amounts of the investments received to date, using the formula set forth above or a pari-mutuel rule. As explained further below, a quote server accessible to users such as potential investors computes the projected return at regular intervals before the start time, and transmits the projected returns to potential investors, step 18, such as over the Internet. Investments continue to be accepted, and projected return recalculated, until a time close to the start time is reached, step 20, which is set as the stop for all orders. Once that time is reached, further investment activity in the derivative is closed and the final return may be computed, step 22.

In one embodiment, the derivatives may be traded in a secondary in which derivatives are traded after they are initially offered by the broker in the primary market. The primary market of the present example is represented in step 14 when investments in the derivative and its one or more complements are accepted from investors. A secondary market for the derivative is created when an investor sells a derivative purchased in step 14 to another party before the stop for all primary market orders for the derivative takes place in step 20. For example, in order to avoid having their investment affect the recalculation of potential returns for the derivative that takes place in step 16, an investor could obtain previously purchased (in step 14) derivatives from another investor thus creating a secondary market. The value of any given derivative would be set by normal market concepts such as supply and demand, etc.

At the start time, the value of the base investment vehicle or vehicles for the derivative is captured and stored, step 24. During the duration of the time period, value changes in the investment vehicles are monitored, step 26, and transmitted to investors for display on their computers, step 28. This process is repeated until the end time or duration is reached, step 30, at which point the value of each base investment vehicle is captured and stored, step 32 (FIG. 1B).

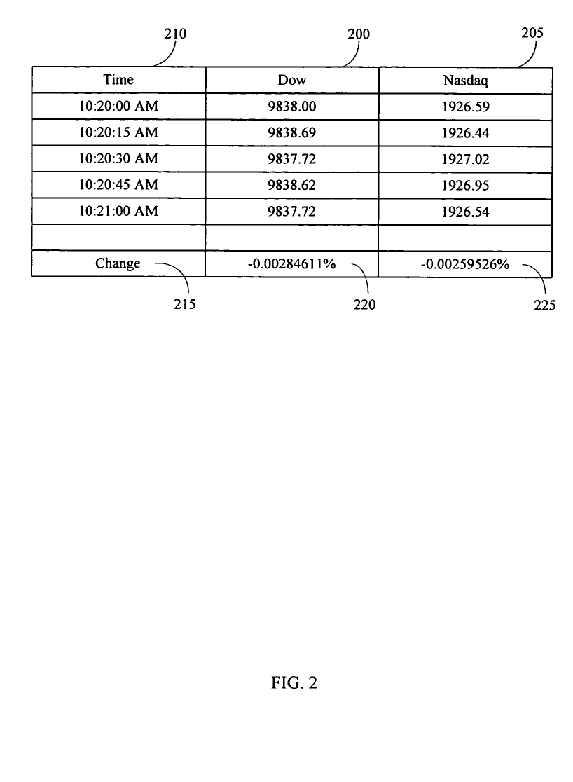

FIG. 2 is an exemplary screenshot on an investor's display of the results of a periodic, ongoing display of value changes in two base investment vehicles, the DOW Jones Industrial Average and the NASDAQ Composite Index. The screenshot depicts the value of the DOW Jones Industrial Average 200 over a period of 60 seconds, the value of the NASDAQ Composite Index 205 over the same period of 60 seconds, various time intervals 210 during this period of 60 seconds during which the values of the DOW Jones Industrial Average 200 and the NASDAQ Composite Index 205 are represented, and a results indicator 215 listing the percentage change of the DOW Jones Industrial Average 220 and the percentage change of the NASDAQ Composite Index 225 during this period of 60 seconds.

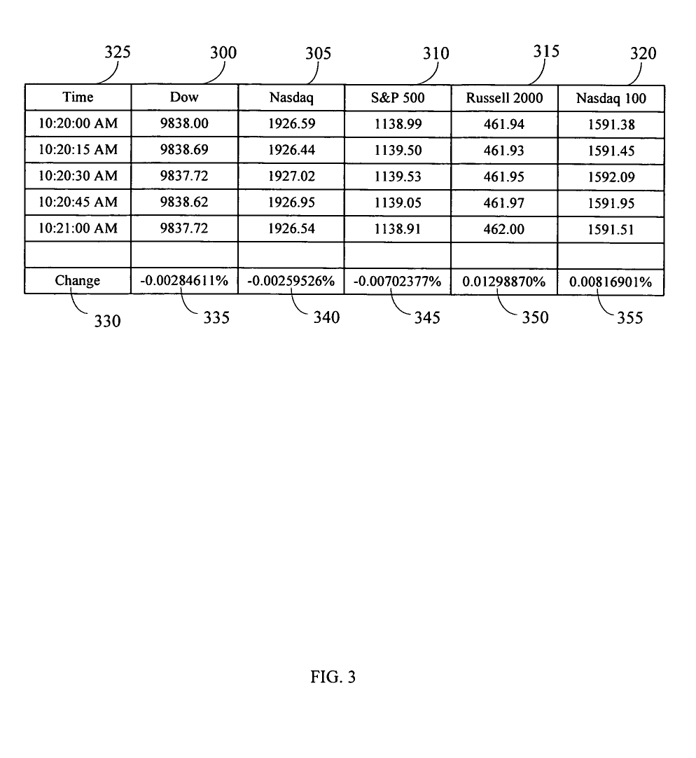

FIG. 3 is an exemplary screenshot on an investor's display of the results of a periodic, ongoing display of value changes in five investment vehicles. The screenshot depicts the value of the DOW Jones Industrial Average 300 over a period of 60 seconds, the value of the NASDAQ Composite Index 305 over the same period of 60 seconds, the value of the Standard & Poor's 500 Index 310 over the same period of 60 seconds, the value of the Russell 2000 Index 315 over the same period of 60 seconds, the value of the NASDAQ 100 Index 320 over the same period of 60 seconds, various time intervals 325 during this period of 60 seconds during which the values of the DOW Jones Industrial Average 300, the NASDAQ Composite Index 305, the Standard & Poor's 500 Index 310, the Russell 2000 Index 315, and the NASDAQ 100 Index 320 are represented, and a results indicator 330 listing the percentage change of the DOW Jones Industrial Average 335, the NASDAQ Composite Index 340, the Standard & Poor's 500 Index 345, the Russell 2000 Index 350, and the NASDAQ 100 Index 355 during this period of 60 seconds.

Returning again to FIG. 1B, following the end time a determination is made which of the derivative or its complement(s) has a positive, nonzero return. In the example of FIG. 2, the derivative with the positive return is the one whose base vehicle performed better, which in this example was the Nasdaq, since it decreased less percentage-wise than the Dow. Then, for each investor in such derivative, step 36, the investor's return is computed based on the amounts invested as described above, step 38, and that return is credited to the investor's account, step 40. This process is repeated for all investors, step 42. Accounting and statistics may then be processed, step 44.

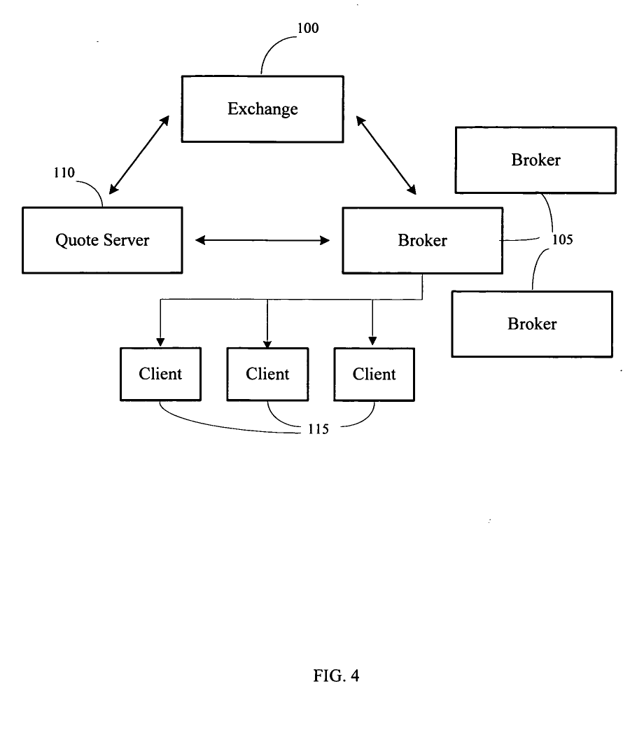

FIG. 4 is a block diagram depicting a high level view of the network architecture and components of a system in accordance with one embodiment of the invention. As shown, the system comprises a computerized exchange 100, one or more computerized brokers 105, a quote server 110, and client computers 115.

The exchange 100 enables the purchase of short-term financial derivative instruments. The exchange 100 enables individuals, brokers, and dealers to communicate purchase orders for short-term financial derivative instruments using a simple network communication protocol such as a subset of Island ECN's OUCH order execution protocol. The exchange also includes an API for using the protocol.

In some embodiments, brokers 105 communicate purchase orders for short-term derivative instruments to the exchange 100. Communication between the broker 105 and the exchange 100 take place over private lines or via the internet.

When the broker 105 communicates a purchase order for a short-term financial derivative instrument to the exchange 100, the exchange 100 places the order and sends back confirmation to the computerized broker 105 as soon as the trade is complete. Once the short-term derivative instrument expires, after the end time, the exchange 100 also notifies the broker 105 of the results and returns for the investment. The exchange 100 is optimized to accept and respond to thousands of broker 105 requests per second.

An additional function of the exchange 100 is to provide a clearing function with respect to each transaction processed. When a short-term derivative instrument expires, the exchange 100 will net all investments made by a specific broker, dealer, or individual and credit his account with the remaining amount. For example, the exchange 100 might net all of a specific broker's short-term derivative instrument trades and then credit or debit his account at a third party bank with the amount depending on whether there was a net gain or net loss respectively for the broker's trades in a given period of time. This real time clearing function reduces risk to the exchange 100 as well as to the broker 105.

The exchange 100 also has risk management capabilities. The exchange 100 maintains an “at risk” position for each broker 105 and limits this “at risk” position to a specific amount. The specific amount allocated to a broker 105 might vary depending on creditworthiness, net worth, funds on deposit, and other factors material to the broker's 105 ability to repay any monies owed to the exchange 100. The exchange 100 thus monitors and displays in real time the positions of different brokers 105 and stops accepting orders if the position of a particular broker 105 is larger than the specified limit allocated to that broker 105.

The exchange 100 also provides a variety of reporting capabilities with respect to user activities and purchases of short-term financial derivative instruments. For example, the exchange 100 might track and report daily, weekly, monthly, and yearly activities by broker. The exchange 100 might also track activities pertaining to one or more short-term financial derivative instruments during similar periods of time.

The exchange 100 also provides aggregate information regarding short-term financial derivative instrument investment activity to the quote server 110 at regular intervals in order for the quote server 110 to compute and disseminate to the brokers 105 the expected rate of return for all short-term financial derivative instruments currently being traded. While the exchange 100 enables trading of short-term derivative instruments and tracks account activities, the quote server 110 actually computes the rate of return for each short-term financial derivative instrument in the preferred embodiment.

The broker 105 securely communicates to the exchange 100 customer orders to purchase short-term financial derivative instruments. The broker 105 functions very much like an online broker and conforms to all the regulations required from NASD brokers. One important distinction, however, is that the broker 105 can only purchase short-term financial derivative instruments offered on the exchange 100. All brokers 105 connect to the exchange 100 using the same network communication protocol and no broker 105 has preferential treatment to other brokers 105.

The broker 105 automatically tracks and maintains online accounts for customers. The broker 105 further enables each account to be opened completely online. The broker 105 accepts cash transfers and withdrawals via many different pay methods such as ACH, paypal, e-cash, credit cards, wire transfers, etc.

The broker's 105 graphical user interface (“GUI”) provides quotes and trading in short-term derivative instruments. The broker's 105 user interface also easily allows customers to view and download history, day activity, their customer account profile, and other useful information. The broker 105 further provides electronic reporting to customers after each trade and also at other intervals such as weekly, monthly, and yearly. The broker 105 allows also customers to easily change their account profile such as their e-mail, their mailing address, their password and other related information. The broker 105 also provides reporting capabilities for managing the brokerage.

The quote server 110 calculates the rate of return for short-term financial derivative instruments based on information received from the exchange 100 regarding the amount invested in each short-term financial derivative instrument. The quote server 110 is primarily a communications device that disseminates quotes for short-term financial derivative instruments. A quote for a short-term financial derivative instrument is not the price of the short-term financial derivative instrument, but instead the expected rate of return for marginal dollar invested in that short-term financial derivative instrument at that point in time.

The quote server 110 receives via a simple network protocol at regular intervals from the exchange 100 the amounts invested in short-term financial derivative instruments available for trading at that time. Based on these amounts, the quote server 110 computes the rate of return or quote for that particular point in time and disseminates or pushes the quote to client computers 115 of customers and/or brokers 105 who are logged into the quote server 110. The quote server 110 also answers structured requests such as HTML requests for quotes from client computers 115 and brokers 105 that wish to pull the quotes from the quote server 110 instead of having the quotes pushed to them by the quote server 110.

The system supports two primary types of customers: online brokers 105 and retail customers. Retail customers access the broker 105 via a web site. New retail customers then go through the process of opening an account which is a completely electronic process. Then they will fund the account by one of several methods. For example, one method would be by transferring cash electronically from one of their accounts or by sending a check. Other methods such as credit card and PayPal would also be considered. The customer is optionally charged if the transfer incurs significant costs for the broker 105. The process is very much the same as existing online brokers who have complete electronic account opening.

After the customer's account is open and funded, they are then allowed to purchase short-term derivatives through a simple online interface. Purchases may comprise market orders, limit order, or other types of orders which may be adapted to purchase short-term derivatives. The broker 105 checks if the customer has sufficient funds in their account and if so, then forwards the buy order to the exchange 100 as well as a pending notification to the customer. The broker 105 also debits the customer's account. When confirmation for the purchase is received from the exchange 100, a trade confirmation is displayed to the client 115. The customer is not able to cancel purchases once such a confirmation is given.

After the short-term derivative expires, the broker 105 receives the results from the exchange 100 and credits the customers account if there was a return on his investment. The customer can also view reports such as day trading history and pending orders. The customer is also able to transfer money to and from his account at the broker to accounts at other banks and brokers.

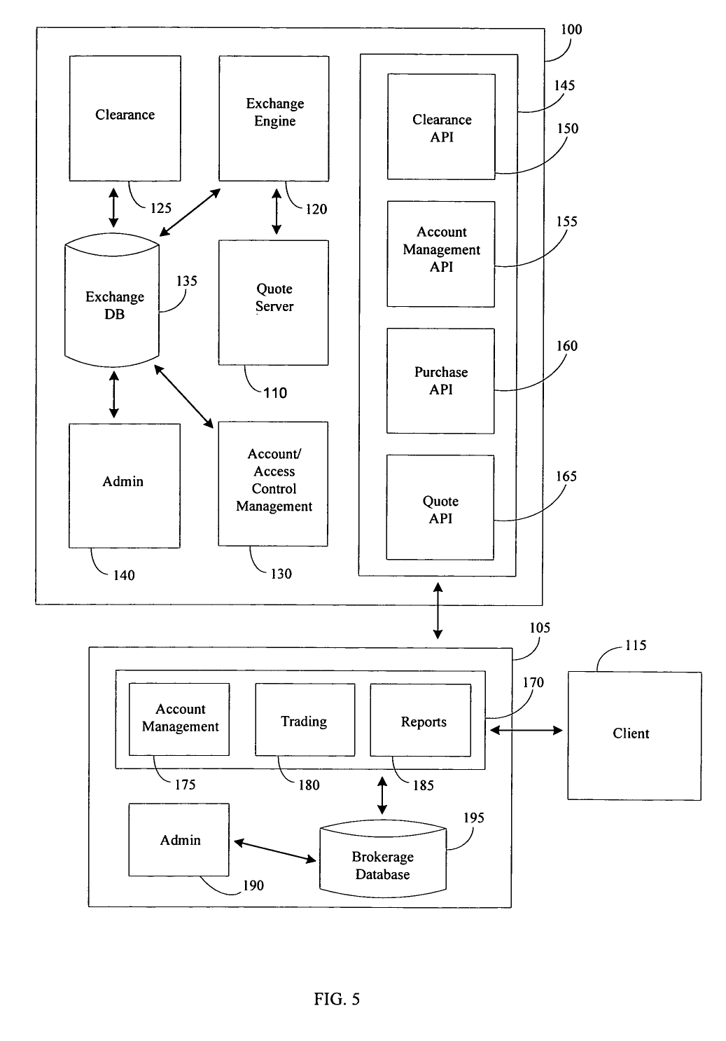

FIG. 5 is a block diagram depicting a view of the network architecture and components of a system in accordance with one embodiment of the invention. As shown, the system comprises a computerized exchange 100, a computerized broker 105, a quote server 110, a client computer 115, an exchange engine 120, a clearance module 125, an account/access control management module 130, an exchange database 135, an exchange administration module 140, an exchange API 145, a clearance API module 150, an exchange account management API module 155, a purchase API module 160, a quote API module 165, a brokerage API 170, a brokerage account management API module 175, a trading API module 180, a reports API module 185, a brokerage administration module 190, and a brokerage database 195.

The exchange API 145 provides an interface for computerized brokers 105 and client computers 115 to communicate with the computerized exchange 100. The exchange account management API module 155 accesses program logic stored in the account/access control management module 130, as well as information stored in the exchange database 135, to provide user authentication and account maintenance services. Users can login to the computerized exchange 100, set account preferences, track profits and losses, modify payment and contact information, and perform other account related operations useful in buying and selling short-term financial derivative instruments. The quote API module 165 communicates with the quote server 110 and the exchange database 135 to provide price quotations for short-term financial derivative instruments. The purchase API module 160 communicates with the exchange engine 120 and the exchange database 135 to purchase short-term financial derivative instruments as requested by computerized brokers 105 and computer clients 115. The clearance API module 145 communicates with the clearance module 125 to reconcile a broker trading accounts. For example, the clearance API module 145 might net all of a specific broker's short-term derivative instrument trades in a given period of time providing a real time clearing function. The exchange administration module 140 provides administrative services for managing the computerized exchange 100 such as reporting tools, storage preferences, security settings, communication settings, and other useful features.

The brokerage API 170 provides an interface for computerized exchanges 100 and computer clients 115 to communicate with the computerized broker 105. The brokerage account management API module 175 provides user authentication and account maintenance services. Computer clients can login to the computerized broker 105, set account preferences, track profits and losses, modify payment and contact information, and perform other account related operations useful in buying and selling short-term financial derivative instruments. The trading API module 180 accepts instructions from computer clients 115 to buy and sell short-term financial derivative instruments. The trading API module 180 communicates these instructions to the computerized exchange 100 for further processing. For example, the purchase API module 160 may be contacted to execute orders or the quote API module 165 may be contacted to request a price on a particular short-term financial derivative instrument. The trading API module 180 also updates the brokerage database 195 with information regarding trades executed by computer clients 115. The reports API module 170 accesses the brokerage database to provide reporting functions regarding trading activities. For example, computer clients may request reports regarding their trading accounts, the brokerage administration module 190 may request aggregate trading activity reports, and the computerized exchange 100 may request brokerage trading reports. The brokerage administration module 190 also provides administrative services for managing the computerized broker 195 such as reporting tools, storage preferences, security settings, communication settings, and other useful features.

Appendix A contains a form call option contract for short term derivatives and Appendix B contains a form investment contract for short term derivatives.

While the invention has been described and illustrated in connection with preferred embodiments, many variations and modifications as will be evident to those skilled in this art may be made without departing from the spirit and scope of the invention, and the invention is thus not to be limited to the precise details of methodology or construction set forth above as such variations and modification are intended to be included within the scope of the invention.

### APPENDIX A

### Sample Call Option Contract

The Call Option Holder hereby tenders payment of the Individual Call Option Purchase Price Amount to the Issuer of the Call Option and agrees to the following terms and conditions, and in consideration of receipt of the Individual Call Option Purchase Price Amount and the Call Option Holder's agreement to the following terms and conditions, the Issuer of the Call Option agrees to the following terms and conditions:

1. Market Performance Scenario One If the Market Performance of the Specified Index equals or exceeds the Market Performance of each Alternative Index during the Option Period, Issuer, upon tender by the Call Option Holder of the Call Option, shall within ______ hours of expiration of the Option Period either:

(a) deliver to the Call Option Holder for no additional consideration freely tradable exchange-traded [options on Specified Index futures] having a fair market value equal to at least [125]% of an amount equal to (x) the Per Dollar Return (as defined below) multiplied by (y) the Individual Call Option Purchase Price Amount; or

(b) pay to the Call Option Holder a return per dollar invested (the “Per Dollar Return”) equal to (x) the Option Holder Percentage times (y) $1 plus (i) the aggregate Individual Call Option Purchase Price Amounts paid to the Issuer in purchase of Contra Options with respect to the Option Period, divided by (ii) the sum of the aggregate amounts paid to the Issuer with respect to all Parallel Call Options.

2. Method of Settlement The Method of settlement of the Call Option shall be in the sole discretion of the Issuer of the Call Option and, in the absence of specific written notice from the Issuer of the Call Option to the Call Option Holder advising of settlement by delivery of non-cash consideration, all settlement shall be in cash by payment of the amount specified in clause (y) of Section 1 above.

3. Market Performance Scenario Two If the Market Performance of the Specified Index is less than the Market Performance of each Alternative Index during the Option Period, no amount shall be due from the Issuer of the Call Option to the Call Option Holder.

4. Market Performance Scenario Three If the Market Performance of the Specified Index is less than the Market Performance of one Alternative Index during the Option Period, but equals or exceeds the Market Performance of any other Alternative Index during the Option Period, no amount shall be due from the Issuer of the Call Option to the Call Option Holder.

5. Defined Terms The following defined terms shall apply to this Call Option:

(a) “Call Option Holder” shall mean the individual or entity that purchases this Call Option in accordance with the applicable account procedures and option trading procedures specified by the Issuer.

(b) “Individual Call Option Purchase Amount” shall mean the cash payment made by the undersigned for, and received by the Issuer with respect to this Call Option Contract.

(c) “Issuer” shall mean The STEEDs Company, Inc., a Delaware corporation and the issuer of this Call Option.

(d) “Market Performance” with respect to any Specified Index or Alternative Index during any time period shall mean the percentage increase or decrease during that time period in the Specified Index or Alternative Index, as the case may be.

(e) “Option Terms Schedule” shall mean the schedule of terms identifying the Option Period, Specified Index, at least one Alternative Index and any other additional terms with respect to this Call Option, and hyper-linked to the Issuer's internal ticker symbol for this Call Option on the Issuer's trading site for such options.

(f) “Specified Index” shall have the meaning ascribed to such term in the Option Terms Schedule.

(g) “Alternative Index” shall have the meaning ascribed to such term in the Option Terms Schedule.

(h) “Option Period” shall have the meaning ascribed to such term in the Option Terms Schedule.

(i) “Option Holder Percentage” shall be 90% unless a lesser amount is specified in the Option Terms Schedule, in which case it shall be such lesser amount.

(j) “Parallel Call Options” shall mean all binding call options (including this Call Option) between the Issuer and individuals or entities which provide for delivery or cash settlement by the Issuer to such individuals' or entities' respective individual investment amounts if the Market Performance of the Specified Index equals or exceeds the Market Performance of each Alternative Index during the Option Period with respect to this Call Option.

(k) “Other Conforming Call Options” shall mean all other binding call options (excluding this Call Option) between the Issuer and individuals or entities which provide for delivery or cash settlement by the Issuer to such individuals' or entities' respective individual investment amounts if the Market Performance of the Specified Index equals or exceeds the Market Performance of each Alternative Index during the Option Period with respect to this Call Option.

6. Receipt of Prospectus and Prospectus Supplement. The Call Option Holder hereby acknowledges receipt of the Prospectus and Prospectus Supplement.

7. Investment Representations. The Call Option Holder hereby acknowledges that there is a high degree of risk involved in purchasing the Call Option and has carefully considered the risks involved before making such purchase.

8. Limitation of Liability (Exculpation); Indemnification. In no event shall the Issuer be liable to the Call Option Holder for lost profits or any other consequential, special, punitive, exemplary or incidental damages and the Call Option Holder acknowledges that it bears the risk of any loss arising out of or in connection with the investment made hereunder. In no event shall the Issuer be liable to the Call Option Holder for a breach of this Agreement or otherwise for any amounts in excess of the Individual Call Option Purchase Price Amount. {TC “SECTION XI.10. Governing Law” \fC\1“2”}

9. Governing Law. This Agreement shall be governed by, and construed in accordance with, the laws of the State of New York, applicable to contracts executed in and to be performed entirely within that state, without giving effect to principles of conflicts of law.

10. Arbitration. Any controversy or claim arising out of or relating to this Agreement or the breach thereof will be settled by binding arbitration before a single arbitrator in accordance with the applicable Rules of the American Arbitration Association then in effect, and judgment upon the award rendered by the arbitrator may be entered in any court having jurisdiction. Any such arbitration will be conducted in New York, N.Y. No party hereto nor the arbitrator may disclose the existence, content or results of any arbitration hereunder without the prior written consent of the other parties.

The prevailing party in any proceeding between the Call Option Holder on the one hand, and the Issuer, on the other, shall be entitled to recover the costs of its reasonable attorney's fees and expenses, arbitration filing fees and expenses, and arbitration compensation. The arbitrator shall have the authority to award the foregoing as part of the arbitration proceedings.

11. Electronic Acceptance/Signature. The Call Option Holder hereby consents to Issuer's electronic delivery of all documents and reports relating to this Agreement and understands that paper versions of the Agreement and any related documents will not be delivered to the Call Option Holder. The Call Option Holder has no right, under any circumstances, to receive paper documents from the Issuer. The only way to obtain paper copies is to print them from a computer. The Call Option Holder acknowledges that regular and continuous internet access is required to access all documents relating to this Agreement and that the Call Option Holder should not invest if it does not have such regular and continuous Internet access.

Sample Option Terms Schedule

### DNSP 3\08/15/2002\14:00\60 Option Terms Schedule

Option Period means the 60-second time period commencing at 2:00 PM, U.S. East Coast Time, on Aug. 15, 2002, and ending at 2:01 PM, U.S. East Coast Time, on Aug. 15, 2002.

Specified Index means the Standard & Poor's [500 Index], as reported by ______.

Alternative Index means either of (A) the Dow Jones [Index], as reported by ______; or (B) the NASDAQ Composite [Index], as reported by ______.

[optional; only if standard 10% Issuer “commission” n.a—Option Holder Percentage means ______%.]

### APPENDIX B

### Sample Investment Contract

The Contract Holder hereby tenders payment of the Individual Investment Amount to the Issuer and agrees to the following terms and conditions, and in consideration of receipt of the Individual Investment Amount and the Contract Holder's agreement to the following terms and conditions, the Issuer agrees to the following terms and conditions:

1. Market Performance Scenario One If the Market Performance of the Specified Index equals or exceeds the Market Performance of each Alternative Index during the Investment Period, Issuer within [______] hours of expiration of the Investment Period shall pay to Contract Holder a return per dollar invested equal to (x) the Contract Investor Percentage times (y) $1 plus (i) the aggregate Individual Investment Amounts paid to the Issuer in exchange for Contra Investment Contracts with respect to the Investment Period, divided by (ii) the sum of the aggregate amounts paid to the Issuer with respect to all Parallel Investment Contracts.

2. Market Performance Scenario Two If the Market Performance of the Specified Index is less than the Market Performance of each Alternative Index during the Investment Period, Issuer shall retain the Individual Investment Amount and the Contract Holder shall not be entitled to any return of, or on, its Individual Investment Amount.

3. Market Performance Scenario Three If the Market Performance of the Specified Index is less than the Market Performance of one Alternative Index during the Investment Period, but equals or exceeds the Market Performance of any other Alternative Index during the Investment Period, Issuer shall retain the Individual Investment Amount and the undersigned shall not be entitled to any return of, or on its Individual Investment Amount.

4. Defined Terms The following defined terms shall apply to this Investment Contract:

(a) “Contract Holder” shall mean the individual or entity that subscribes to this Investment Contract in accordance with the applicable account procedures and investment procedures specified by the Issuer.

(b) “Individual Investment Amount” shall mean the cash payment made by the undersigned for, and received by the Issuer with respect to this Investment Contract.

(c) “Issuer” shall mean The STEEDs Company, Inc., a Delaware corporation and the issuer of this Investment Contract.

(d) “Market Performance” with respect to any Specified Index or Alternative Index during any time period shall mean the percentage increase or decrease during that time period in the Specified Index or Alternative Index, as the case may be.

(e) “Contract Terms Schedule” shall mean the schedule of terms identifying the Investment Period, Specified Index, at least one Alternative Index and any other additional terms with respect to this Investment Contract, and hyper-linked to the Issuer's internal ticker symbol for this Investment Contract on the Issuer's trading site for such investment contracts.

(f) “Specified Index” shall have the meaning ascribed to such term in the Contract Terms Schedule.

(g) “Alternative Index” shall have the meaning ascribed to such term in the Contract Terms Schedule.

(h) “Investment Period” shall have the meaning ascribed to such term in the Contract Terms Schedule.

(i) “Contract Investor Percentage” shall be 90% unless a lesser amount is specified in the Contract Terms Schedule, in which case it shall be such lesser amount.

(j) “Contra Investment Contracts” shall mean all other binding investment contracts between the Issuer and individuals or entities which provide for a return of, or on, such individuals' or entities' respective individual investment amounts if the Market Performance of an Alternative Index equals or exceeds the Market Performance of the Specified Index during the Investment Period with respect to this Investment Contract.

(k) “Parallel Investment Contracts” shall mean all binding investment contracts (including this Investment Contract) between the Issuer and individuals or entities which provide for a return of, or on, such individuals' or entities' respective individual investment amounts if the Market Performance of the Specified Index equals or exceeds the Market Performance of each Alternative Index during the Investment Period with respect to this Investment Contract.

5. Receipt of Prospectus and Prospectus Supplement. The Call Option Holder hereby acknowledges receipt of the Prospectus and Prospectus Supplement.

6. Investment Representations. The Call Option Holder hereby acknowledges that there is a high degree of risk involved in purchasing the Call Option and has carefully considered the risks involved before making such purchase.

7. Limitation of Liability (Exculpation); Indemnification. In no event shall the Issuer be liable to the Call Option Holder for lost profits or any other consequential, special, punitive, exemplary or incidental damages and the Call Option Holder acknowledges that it bears the risk of any loss arising out of or in connection with the investment made hereunder. In no event shall the Issuer be liable to the Call Option Holder for a breach of this Agreement or otherwise for any amounts in excess of the Individual Call Option Purchase Price Amount. {TC “SECTION XI.10. Governing Law” \fC\1“2”}

8. Governing Law. This Agreement shall be governed by, and construed in accordance with, the laws of the State of New York, applicable to contracts executed in and to be performed entirely within that state, without giving effect to principles of conflicts of law.

9. Arbitration. Any controversy or claim arising out of or relating to this Agreement or the breach thereof will be settled by binding arbitration before a single arbitrator in accordance with the applicable Rules of the American Arbitration Association then in effect, and judgment upon the award rendered by the arbitrator may be entered in any court having jurisdiction. Any such arbitration will be conducted in New York, N.Y. No party hereto nor the arbitrator may disclose the existence, content or results of any arbitration hereunder without the prior written consent of the other parties.

The prevailing party in any proceeding between the Call Option Holder on the one hand, and the Issuer, on the other, shall be entitled to recover the costs of its reasonable attorney's fees and expenses, arbitration filing fees and expenses, and arbitration compensation. The arbitrator shall have the authority to award the foregoing as part of the arbitration proceedings.

10. Electronic Acceptance/Signature. The Call Option Holder hereby consents to Issuer's electronic delivery of all documents and reports relating to this Agreement and understands that paper versions of the Agreement and any related documents will not be delivered to the Call Option Holder. The Call Option Holder has no right, under any circumstances, to receive paper documents from the Issuer. The only way to obtain paper copies is to print them from a computer. The Call Option Holder acknowledges that regular and continuous internet access is required to access all documents relating to this Agreement and that the Call Option Holder should not invest if it does not have such regular and continuous Internet access.

Sample Option Terms Schedule

### DNSP3\08/15/2002\14:00\60 Option Terms Schedule

Option Period means the 60-second time period commencing at 2:00 PM, U.S. East Coast Time, on Aug. 15, 2002, and ending at 2:01 PM, U.S. East Coast Time, on Aug. 15, 2002.

Specified Index means the Standard & Poor's [500 Index], as reported by ______.

Alternative Index means either of (A) the Dow Jones [Index], as reported by ______; or (B) the NASDAQ Composite [Index], as reported by ______.

[optional; only if standard 10% Issuer “commission” n.a—Option Holder Percentage means ______%.]

Sample Contract Terms Schedule

DNSP 3\08/15/2002\14:00\60 Contract Terms Schedule

Investment Period means the 60-second time period commencing at 2:00 PM, U.S. East Coast Time, on Aug. 15, 2002, and ending at 2:01 PM, U.S. East Coast Time, on Aug. 15, 2002.

Specified Index means the Standard & Poor's [500 Index], as reported by ______.

Alternative Index means either of (A) the Dow Jones [Index], as reported by ______; or (B) the NASDAQ Composite [Index], as reported by ______.

[optional; only if standard 10% Issuer “commission” n.a—Contract Investor Percentage means ______%.]

1. A method for offering short term investments, the method comprising:
storing data representing a set of two or more investment vehicles having values that change over time;
accepting investments in a plurality of derivative instruments from investors, the derivative instruments each representing relative value change of one of the investment vehicles as compared to the one or more other investment vehicles in the set over a defined, near real-time period having a duration long enough to allow for a high probability of value change in the investment vehicles in the set;
providing a return on the derivative instruments following the defined time period based upon the relative value change of the investment vehicles.

2. The method of claim 1, comprising tracking the values of the investment vehicles during the defined time period.

3. The method of claim 2, comprising displaying to the investors the tracked value changes of the investment vehicles during the defined time period.

4. The method of claim 1, comprising defining the time period to have a duration to allow for only a few value changes in the investment vehicles during the time period.

5. The method of claim 4, wherein defining the time period comprises defining the time period based on historical data showing rates of value change of the investment vehicles in the set.

6. The method of claim 1, comprising defining the time period to have a duration short enough to retain nearly continuous interest of the investors in value changes of the investment vehicles during the time period.

7. The method of claim 1, wherein storing data comprises storing data representing a set of two or more indexes.

8. The method of claim 7, wherein storing data comprises storing data representing a set including at least one of a Dow Jones index, a NASDAQ index, a Standard & Poor's 500 index, and a Russell index.

9. The method of claim 7, wherein the duration of the defined time period is five minutes or less.

10. The method of claim 9, wherein the duration of the defined time period is one minute.

11. The method of claim 1, wherein providing the return comprises providing a return only to one or more investors in the derivative instrument whose relative value change as compared to the other one or more investment vehicles in the set is favorable according to a predetermined criteria.

12. The method of claim 11, wherein providing the return comprises providing the return to the one or more investors in the derivative instrument whose percentage value change as compared to percentage value changes of the other one or more investment vehicles in the set is favorable according to a predetermined criteria.

13. The method of claim 12, wherein providing the return comprises providing the return to the one or more investors in the derivative instrument whose percentage value change increased more than or decreases less than the percentage value changes of the other one or more investment vehicles in the set.

14. The method of claim 11, wherein providing a return comprises computing the return for each investor as a function of an amount invested by the investor in the investor's derivative instrument and amounts invested in each of the derivative instruments.

15. The method of claim 14, wherein computing the return comprises computing the return according to a pari-mutuel return rule.

16. The method of claim 14, comprising, at each of a plurality of given times prior to the defined time period, computing a projected return for each derivative instrument and transmitting the projected returns to potential investors for display on display devices.

17. The method of claim 1, comprising accepting investments in a plurality of derivative instruments from investors, the derivative instruments each representing relative value change of one of the investment vehicles as compared to the one or more other investment vehicles in the set over one or more different defined, near real-time periods having a duration long enough to allow for a high probability of value change in the investment vehicles of the set.

18. The method of claim 17, comprising:
accepting investments in a plurality of “super” derivative instruments from investors, the “super” derivative instruments each representing combinations of relative value changes of the derivative instruments during the different defined, near real-time periods;
providing a return on the “super” derivative instruments based upon the performance of the derivative instruments during the different defined time periods.

19. A method for offering short term investments, the method comprising:
for a selected investment vehicle, defining a period of time having a duration long enough to allow for a high probability of at least one value change in the investment vehicle during the time period but not more than a few value changes in the investment vehicle during the time period;
accepting investments in a plurality of derivative instruments from investors, the derivative instruments each representing one of a plurality of possible value changes of the investment vehicle over the defined time period;
computing a return on the derivative instruments for each investor as a function of an amount invested by the investor in the investor's derivative instrument and amounts invested in each of the derivative instruments;
providing the return on the derivative instruments following the defined time period based upon the value change of the investment vehicle.

20. The method of claim 19, wherein accepting the investments comprises accepting investments in two derivative instruments, a first derivative instrument representing an increase in value of the investment vehicle over the defined time period and a second derivative instrument representing a decrease in value of the investment vehicle over the defined time period.

21. The method of claim 19, wherein the investment vehicle is an index, and defining the time period comprises defining the duration as five minutes or less.

22. The method of claim 19, wherein computing the return comprises computing the return according to a pari-mutuel return rule.

23. The method of claim 19, comprising, at each of a plurality of given times prior to the defined time period, computing a projected return for each derivative instrument and transmitting the projected returns to potential investors for display on display devices.

24. A system for offering short term investments, the system comprising:
a computerized exchange for storing data representing a set of two or more investment vehicles having values that change over time and for accepting investments in a plurality of derivative instruments from investors, the derivative instruments each representing relative value change of one of the investment vehicles as compared to the one or more other investment vehicles in the set over a defined, near real-time period having a duration long enough to allow for a high probability of value change in the investment vehicles in the set;
a computerized quote server coupled to the exchange for, at each of a plurality of given times prior to the defined time period, computing a projected return for each derivative instrument and transmitting the projected returns to potential investors for display on display devices.

25. The system of claim 24, comprising means for connecting the exchange to a plurality of broker systems for offering the derivative instruments.

26. The system of claim 24, comprising a data feed receiving system coupled to the exchange for receiving real-time data regarding the values of the investment vehicles.

27. The system of claim 24, wherein the exchange comprises means for providing a return on the derivative instruments following the defined time period based upon the relative value change of the investment vehicles.

28. The system of claim 24, wherein the quote server comprises means for receiving investment data from the exchange representing amounts invested at a given time in the derivative instruments, and wherein the quote server computes a projected return for each derivative instrument as a function of an amount invested in the derivative instrument and amounts invested in each of the other derivative instruments at the given time.

29. The system of claim 28, wherein the quote server comprises a processor programmed to compute the projected returns using a pari-mutuel return rule.
